(19) United States
(12) Patent Application Publication
(10) Pub. No.: US 2007/0242730 A1
(43) Pub. Date: Oct. 18, 2007

(54) Adaptive Mostly-Digital Ultra-Wide Band Receiver

(75) Inventor: Dagnachew Birru, Yorktown Heights, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/570,435

(22) PCT Filed: Jun. 10, 2005
(86) PCT No.: PCT/IB05/51929

§ 371 Date: Dec. 12, 2006

Related U.S. Application Data
(60) Provisional application No. 60/579,552, filed on Jun. 14, 2004.

(51) Int. Cl. H04B 1/69

(52) U.S. Cl. 375/130; 375/316

(57) ABSTRACT

A mostly-digital ultra-wideband (UWB) receiver that includes an adaptive combiner (125) having a matched filter with adaptive filter weights selected to maximize the output signal-to-noise (SNR) ratio and be insensitive to noise, channel and timing errors as the adaptive combiner is not dependent on the shape of the transmitted waveform in an adaptive filter-weight scheme. The receiver includes an UWB input filter 105 for filtering analog UWB RF input pulses; at least one parallel sub-sampling analog-to-digital converter (ADC) (120) for converting the filtered UWB RF analog pulses output from the UWB filter (105) into sub-sampled digital signals. An adaptive combiner (125) sums the sub-sampled digital waveforms output by the parallel ADC (120); and a polyphase clock generator (122) that provides the parallel ADC (120) with clock control pulses so that the sub-sampling ADC (120) only sub-samples and converts the filtered UWB RF analog wave only where a threshold of an expected energy of each pulse exists.

The present invention relates to apparatuses and processes designed for use in Ultra-Wide Band (UWB) communication systems and networks. More particularly, the present invention relates to a technique for shifting most of the processing in UWB communications into the digital domain with an adaptive pulse detection scheme.

Ultra-Wide Band (UWB) communication, in general, is classically defined as a ratio of bandwidth that is occupied relative to a modulation bandwidth, wherein the occupied bandwidth is approximately 20-25% of the center frequency or greater than 1.5 GHz. The typical UWB modulation uses a scheme that transmits pulses having a duration that is very short, and where the occupied bandwidth is a very large value. In particular, UWB modulation is known to use either bi-phase modulated pulse position modulation, or time-modulated pulse-position modulation.

UWB, which is sometimes referred to as impulse radio or zero-carrier technology, typically transmits pulses of approximately 10-1000 picoseconds in duration. The radiated energy, which occupies a large bandwidth, is often made sufficiently small so that it can co-exist with other devices without causing harmful interference to them. Some of the advantages of current UWB implementations include low-cost, low power, and resilience to multipath interference. Such benefits are typically true of the current relatively low data-rate applications where the transmitted short pulses are sufficiently separated in time. With the adoption by the FCC of the 3.1-10.6 GHz band for UWB communications, there has been some interest in examining whether UWB is suitable for high data-rate (>100 Mb/s) WPAN (Wireless Personal Area Network) applications.

A typical UWB implementation designed for a low data rate application is based on pulse detection using either tunnel diodes or correlation implemented in the analog domain. These techniques normally do not provide optimum matched filtering since the received waveform does not match with the characteristics of the pulse detector. As a result, such implementations are sensitive to channel conditions and interference. In addition, the correlation method applied directly at the RF signal is also highly sensitive to the wave shape and timing mismatches. As the implementations are in the analog domain, the aforementioned techniques limit the use of advanced interference mitigation techniques for UWB. Thus, there is a need to provide UWB communications that are primarily processed in the digital domain instead of analog, and to provide a pulse detection scheme that is matched to channel and insensitive timing errors.

The presently claimed invention provides a method and an apparatus for providing a mostly-digital UWB receiver. According to an aspect of the invention includes a line filter, a low noise amplifier, a gain controller, a pair of A/D converters that sample the signal only during the time where most of the expected energy of the pulse exists. A n adaptive combiner then combines the output of the pair of converters. Then, the output of the adaptive combiner is fed to an equalizer. The adaptive combiner is not sensitive to noise, channel, or timing errors, as the adaptive combiner is not dependent on the shape of the transmitted waveform in an adaptive filter-weight scheme, as is known in the art of UWB receivers.

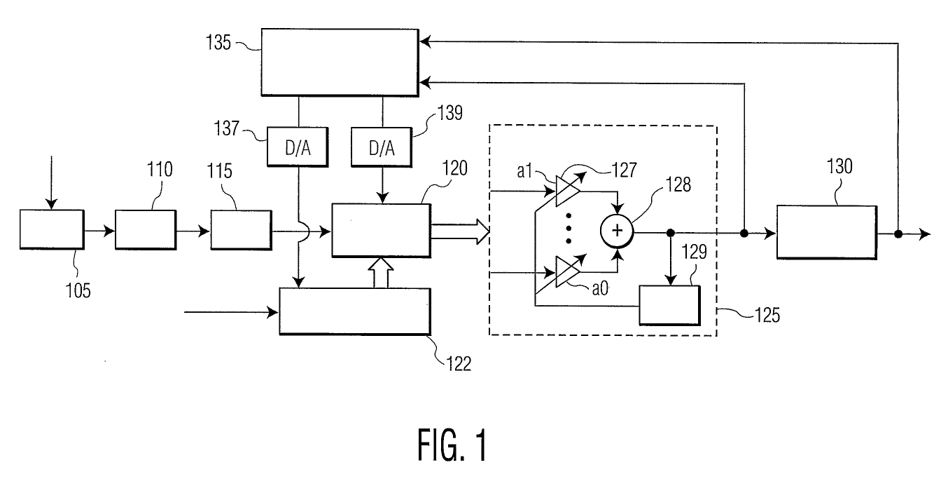

FIG. 1 is a schematic of a system according to the present invention.

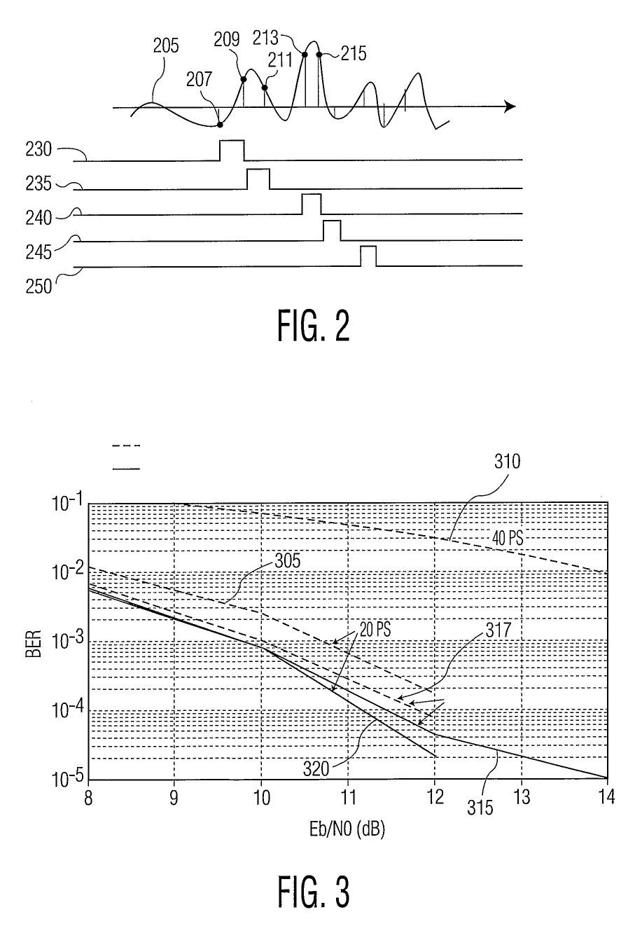

FIG. 2 illustrates the output of polyphase clocks and sub-sampling of a signal.

FIG. 3 is an illustration of the bit error rate (BER) as a function of signal-to-noise ratio SNR.

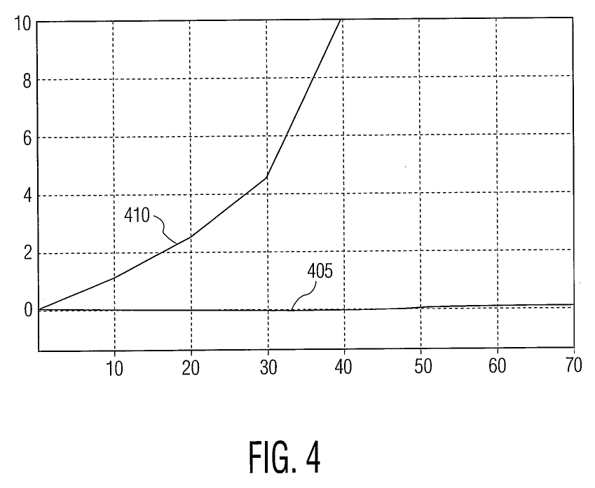

FIG. 4 illustrates a simulated performance loss caused by timing errors.

It is to be understood by persons of ordinary skill in the art that the following descriptions are provided for purposes of illustration and not for limitation. An artisan understands that there are many variations that lie within the spirit of the invention and the scope of the appended claims. Unnecessary detail of known functions and operations may be omitted from the current description so as not to obscure the finer points of the present invention.

FIG. 1 is an overview of one arrangement of an adaptive mostly-digital (AMD) ultra-wideband receiver according to the present invention. As shown in FIG. 1 an UWB RF input is initially passed through filter 105. The filter 105 is designed to remove out of band signals and inband narrowband interferers. One way that such a filter may be implemented is through the use of transmission line filters.

The output of the filtered UWB input is passed through a low-noise amplifier (LNA) 110. The LNA increases the strength of the desired UWB signal, which to some degree was attenuated by passage through the filter 105. The amplified signal is then input to automatic gain controller (AGC) 115. The AGC adjusts the signal to a predetermined level, and its output is then converted into a digital signal by be input to parallel analog-to-digital converters (ADCs) 120. The output of the adaptive combiner 125 is then input to an equalizer to mitigate any inter-symbol interference caused by the channel. The output from the equalizer 130 and optionally the adaptive combiner 125 are fed back to a microprocessor controller 135. The microprocessor 135 in turn provides control signals to both the delay lines 122 and the parallel ADCs 120 via digital-to-analog converters (137, 139), respectively.

According to an aspect of the present invention, the ADCs 120 only sample the signal during the time where most of the expected energy of the pulse exists. One way that the sampling of the ADCs 120 may be controlled is through the use of a polyphase clock generator (delay line) 122, which receives the master clock input shown in FIG. 1. The polyphase clock generator 122 includes a plurality of delay lines on the order of pico-second delays. Thus, the amount of delay of the clock introduced to control the sampling of the ADCs 120 can be very precise. For example, the accuracy of the ADC may range from 1 bit (used as a threshold detector) to several bits.

In addition, the ADCs 120 can be preceded by a number of fast sample and hold circuits (not shown). It is to be understood by persons of ordinary skill in the art that the number of individual ADC's, their accuracy, and the delay line will all be chosen to satisfy a certain predetermined cost-performance targets, and all of these items needs may be varied to satisfy any particular need. Thus, although FIG. 1 shows one box labeled “parallel ADCs” it is to be understood that this illustration is merely for explanatory purposes, and the number of sampling ADCs, the types of delay lines, and whether or not to use additional fast sample and hold circuits preceding the ADC are all within the spirit of the invention and the scope of the appended claims.

The sampled digital output of the ADCs 120 is then input to an adaptive combiner 125. The adaptive combiner 125 performs a summing of the sub-sampled digital waveforms using adaptive weights. This combiner may be viewed as a matched filter. The adaptive filter weights are selected so as to maximize the output signal-to-noise ratio. The adaptive combiner 125 typically would include at least an input for at least two or more sub-sampled digitally converted signals to be combined, two or more multipliers 127 with each multiplier receiving a respective sub-sampled digitally converted input, an adder 128 that sums the output of the respective multipliers. A difference (error 129) is fed back to the multipliers 127 to adjust the multiplying coefficient (to taps) adaptively. The summed waveform is then output typically to an equalizer, such as shown 130 in FIG. 1.

According to an aspect of the invention, one advantage of the present invention is that the adaptive combiner 125 is not dependent on the shape of the transmitted waveform. For example, conventional UWB receivers will employ filters that are not effectively matched to the received waveform since the received waveform cannot be reliably known due to the multi-path and other filtering modifications. In addition, conventional schemes are very sensitive to channel noise and timing errors. However, as disclosed herein, the presently claimed invention adaptively combines the sub-sampled digital waveforms by adaptively computing the optimum matched filter taps. The result is that the present invention is not sensitive to noise, channel or timing errors.

According to yet another aspect of the invention, assuming that the output of the ADCs 120 can be modeled as:
x(nT)={x(nT), x(nT+t₁)x(nT+t₂) . . . , x(nT+t_{M-1})}
wherein M is the number of sub-samples;
t's are the delays of the sub-sampling cocks; and
T is the symbol rate (pulse rate).

It is noted that the delay line does not have to be a uniform delay line. By defining the weight coefficients as:
a(n)={a₀(nT), a₁(nT), . . . a_{M-1}(nT),}, then the output of the adaptive combiner can be described by:
   y(nT)=a(nT)x^{T}(nT) (Eqn. 1).

The taps of the adaptive combiner (a(nT)) may be obtained using a Least Mean Square (LMS) algorithm, or by one of the blind adaptive algorithms such as a constant modulus adaptive (CMA) algorithm. The LMS algorithm can be described by:
a((n+1)T)=a(nT)+ux(nT)e(nT) (Eqn. 2);

wherein e(nT)=y(nT)−r(nT) is the error, r(nT) is the transmitted sequence and u is the adaptation step constant. It should also be noted that r(nT) may be replaced with the output of a slicer (Decision device) or known training sequence.

FIG. 2 illustrates a simplified form of the nature of polyphase clocks and a sub-sampling of the signal. Here the analog signal 205 is plotted as a function of power verses time. As can be seen from FIG. 2, in this particular UWB transmission, the energy level varies at different times. According to the present invention, the sub-sampling is performed at periods where most of the expected energy exists, such as at points 207, 209, 211, 213, 215, etc. It can be seen that the sub-sampling is triggered by the polyphase clock pulses 230, 235, 240, 245, 250 that control the ADCs 120. From these sub-sampling points, the analog signal is converted by the ADCs 120 (shown in FIG. 1) to a digital signal. As previously stated, the polyphase delays are on the order of picoseconds.

Thus, unlike the correlation method used in the prior art by a direct application to incoming the RF UWB signal, in the present invention there is a shifting of most of the signal processing into the digital domain by sub-sampling the signal only where most of the expected energy of the pulse exists to obtain digital samples, and then combining the sampled digital signal using the adaptive combiner.

In order to evaluate the performance of the present invention, the adaptive computations of optimum matched filter taps combiner by the Adaptive Combiner, the inventors have performed a simulation using a representative UWB scheme. It should be understood that this simulation is presented for explanatory purposes only, and the device is not limited to merely the parameters used in the example. In this simulation, it is assumed that the modulating data is equi-probable binary data. The pulse shape is a Gaussian pulse modulated with a carrier at a center frequency of 5 GHz, occupying substantially about 3 GHz at −10 db bandwidth. The simulation environment was set up for 100 M pulses per second with T=10 ns and modulated using an antipodal modulation technique. The new receiver model according to the present invention comprises a parallel sampler, followed by the adaptive combiner. The response of the new receiver model is compared with an ideal correlation of a conventional receiver wherein the received waveform is known. In contrast, in the new receiver does not have any knowledge of the received waveform.

FIG. 3 illustrates the timing sensitivity aspect of an ideal conventional receiver. In more detail, FIG. 3 provides a plot of the simulated bit-error-rate (BER) for a 20 ps (305) and 40 ps (310) timing offsets. As illustrated by the plot in FIG. 3, the conventional based receiver has good performance lines (315, 317) when there are no timing errors both with an equalizer 315, as opposed to ideally 317. However, when there is a 20 ps timing error, it is noted there are differences between lines 305 versus 320. Thus, the line 320 representing a receiver according to the present invention shows a slight variance for a 20 ps timing error than no timing error 315 after more than a −10 db change in the SNR. Up until somewhat after −10 db the plotted lines 315 and 317 are identical, meaning that there is no change due to timing errors in the SNR up to about −10 db. The conventional UWB plot varies by a considerable distance from a 20 ps error 305 versus no error 317, and at a 40 ps error 310 shows how the BER is significantly varied from the no timing error plot 317 in the conventional receiver. In other words, unlike the plots of the conventional UWB receiver, the UWB according to the present invention has an almost identical BER response for more than a −10 db shift in the SNR. These numbers mean the present invention is not affected by either timing errors or changes in the SNR until about −10 db.

FIG. 4 is a plot of the performance loss as a function of the timing error. The present invention is virtually unaffected by timing offset, whereas the conventional receiver suffers significant losses in performance as the timing offset in increased. It is clearly shown in FIG. 4 that the performance loss for a receiver according to the present invention, which is represented by line 405, is nearly zero. This almost lossless-response contrasts starkly with the response of the conventional receiver, which is represented by line 410. In fact, by about 25 ps of timing error, the conventional receiver already shows a 3 db loss in power, and by 40 ps, the loss is on order of 10 db.

Various modifications to the above invention can be made by persons of ordinary skill in the art that do not depart from the spirit of the invention, or the scope of the appended claims. For example, the components used to construct the adaptive combiner can be substituted, the polyphase clock generator may have different clock values, the microprocessor control of the parallel ADCs and the polyphase clock generator could be based on just the output from the adaptive combiner, or the output of the equalizer. While it is recommended that the low noise amplifier LNA 110 follows the output of the input filter 105, it is still within the spirit of the invention and scope of the appended claims if the LNA is not included. As FIG. 1 shows a master clock input, this master clock could be from the microprocessor, or some other component that specifically provides a master clock pulse to the polyphase clock generator. The energy/power thresholds at which the sub-sampling occurs can also be modified according to need. It is also noted that as UWB can operate across spectrums where the transmissions of pulses range from 10-1000 picoseconds (typically), the effect of the timing errors on the conventional receiver may be somewhat different, but the present invention remains virtually unaffected by changes in timing errors or SNR up to about 10 db or more.

What is claimed is:

1. A mostly-digital ultra-wideband (UWB) receiver comprising:
a UWB input filter 105 for filtering analog UWB RF input pulses;
at least one parallel sub-sampling analog-to-digital converter (ADC) 120 for converting the filtered UWB RF analog pulses output from the UWB filter (105) into sub-sampled digital signals;
an adaptive combiner (125) for summing the sub-sampled digital waveforms output by the parallel ADC (120); and
a polyphase clock generator (122) that provides the parallel ADC (120) with clock control pulses so that the sub-sampling ADC (120) only sub-samples and converts the filtered UWB RF analog wave only where a threshold of an expected energy of each pulse exists.

2. The UWB receiver according to claim 1, further comprising:
a low noise amplifier (LNA) (110) that is arranged between an output of the filter (105) and an input of the sub-sampling ADC (120);
an automatic gain controller (AGC) (115) that is arranged between an output of the LNA (110) and an input of the sub-sampling ADC (120).

3. The UWB receiver according to claim 2, further comprising:
an equalizer (130) attached to an output of the adaptive combiner (125) so as to receive and equalize the summed-digital waveforms output by the adaptive combiner (125); and
a microprocessor controller (135) that receives a portion of an output from the equalizer (130) and a portion of the output of the adaptive combiner (125), so as to control the polyphase clock (122) and the sub-sampling ADC (120) via a respective pair of digital-to-analog D/A converters (137, 139).

4. The UWB receiver according to claim 1, wherein the adaptive combiner (125) comprises a matched filter having adaptive filter weights selected to maximize the output signal-to-noise (SNR) ratio without depending on a shape of a transmitted wave form.

5. The UWB receiver according to claim 4, wherein the input of the adaptive combiner (125) is modeled as:
x(nT)={x(nT), x(nT+t₁)x(nT+t₂) . . . , x(nT+t_{M-1})}
wherein M is the number of sub-samples;
t's are the delays of the sub-sampling cocks; and
T is the symbol rate (pulse rate).

6. The UWB receiver according to claim 5, wherein a plurality of weight coefficients for the adaptive combiner are provided by the following formula:
a(n)={a₀(nT), a₁(nT), . . . a_{M-1}(nT),}, then the output of the adaptive combiner can be described by: y(nT)=a(nT)x^{T}(nT).

7. The UWB receiver according to claim 1, wherein the adaptive combiner (125) computes an optimum of matched filter taps.

8. The UWB receiver according to claim 6, wherein the adaptive combiner computes an optimum of matched filter taps according to a constant modulus adaptive (CMA) algorithm.

9. The UWB receiver according to claim 6, wherein the adaptive combiner (125) computes an optimum of matched filter taps according to a Least Mean Square (LMS) algorithm.

10. The UWB receiver according to claim 9, wherein the LMS algorithm comprises the following formula:
a((n+1)T)=a(nT)+ux(nT)e(nT);
wherein e(nT)=y(nT)−r(nT) is the error, r(nT) is a transmitted sequence and u is an adaptation step constant.

11. The UWB receiver according to claim 10, wherein a value r(nT) comprises one of an output of a slicer (decision device) and a known training sequence.

12. An adaptive combiner for summing sub-sampled digital waveforms output a sub-sampling parallel ADC (120) of an ultra-wideband (UWB) receiver UWB comprising,
at least two multipliers (127) adapted for receiving respective sub-sampled digitally converted inputs of an ultra-wideband waveform;
an adder (128) for summing outputs of the at least two multipliers; and
an output adapted for providing an input to at least one of a microcontroller (135) and an equalizer (130).

13. The adaptive combiner according to claim 12, wherein the combiner (125) comprises a matched filter including adaptive filter weights selected to maximize an output signal-to-noise ratio.

14. The adaptive combiner according to claim 13, where a plurality of taps are computed so as to comprises optimum matched filter taps insensitive to at least one of noise, channel, and timing errors.

15. The adaptive combiner according to claim 13, wherein the filter taps are obtained by using a Least Mean Square algorithm.

16. The adaptive combiner according to claim 15, wherein the LMS algorithm comprises the following:
a((n+1)T)=a(nT)+ux(nT)e(nT);
wherein e(nT)=y(nT)−r(nT) is the error, r(nt) is a transmitted sequence and u is an adaptation step constant.

17. The adaptive combiner according to claim 13, wherein the filter taps are obtained by using a constant modulus adaptive (CMA) algorithm.

18. A method for providing a mostly-digital UWB signals, comprising the steps of:
(a) filtering analog UWB RF input pulses by a UWB input filter (105);
(b) converting the filtered UWB RF analog pulses output from the UWB filter (105) into sub-sampled digital signals by at least one parallel sub-sampling analog-to-digital converter (ADC) (120);
(c) summing the sub-sampled digital waveforms output by the at least one parallel sub-sampling ADC (120) by an adaptive combiner (125); and
(d) providing the parallel ADC (120) with clock control pulses from a polyphase clock generator (122) so that the one parallel sub-sampling ADC (120) only sub-samples and converts the filtered UWB RF analog wave only where a threshold of an expected energy of each pulse exists.

19. The method according to claim 18, further comprising:
(e) receiving and equalizing the summed-digital waveforms output by the adaptive combiner (125) by an equalizer (130) attached to an output of the adaptive combiner (125); and
(f) controlling the polyphase clock (122) and the sub-sampling ADC (120) by a microprocessor controller (135) that receives a portion of an output from the equalizer (130) and a portion of the output of the adaptive combiner (125) via a respective pair of digital-to-analog D/A converters (137, 139).

20. The method according to claim 19, wherein the adaptive combiner (125) computes an optimum of matched filter taps according to one of a constant modulus adaptive (CMA) algorithm and a Least Mean Square (LMS) algorithm.
